(19) United States
(12) Patent Application Publication
(10) Pub. No.: US 2011/0075186 A1
(43) Pub. Date: Mar. 31, 2011

(54) IMAGE PROCESSING APPARATUS, METHOD PERFORMED BY IMAGE PROCESSING APPARATUS, PROGRAM PRODUCT, AND RECORDING MEDIUM THEREFOR

(76) Inventor: Yoshikazu AZUMA, Tokyo (JP)

(21) Appl. No.: 12/891,228

(22) Filed: Sep. 27, 2010

(30) Foreign Application Priority Data
Sep. 30, 2009 (JP) 2009-226914

(51) Int. Cl. G06K 15/02; G06F 3/12

(52) U.S. Cl. 358/1.14; 358/1.15

(57) ABSTRACT

An image processing apparatus according to the present invention includes a sub communication unit that receives an association process request using wireless communication and executes an association process and includes a main communication unit that performs wireless communication in accordance with association information that is used in the association process and in accordance with setup information that is setting information on wireless communication that can be set for each system of the association process request.

### CROSS-REFERENCE TO RELATED APPLICATIONS

The present application claims priority to and incorporates by reference the entire contents of Japanese Patent Application No. 2009-226914 filed in Japan on Sep. 30, 2009.

### BACKGROUND OF THE INVENTION

1. Field of the Invention

The present invention relates to image processing apparatuses and, more particularly, to an image processing apparatus that has a wireless communication function, a method performed by the image processing apparatus, a program product, and a recording medium therefore.

2. Description of the Related Art

In recent years, wireless local area network (LAN) communication, in which data communication is available even when devices are not physically connected to a network, has been rapidly and widely becoming used. Wireless LAN communication includes various communication modes; typical examples thereof are the infrastructure mode and the ad hoc mode, which is the operation mode of the wireless LAN communication that conforms to the IEEE 802.11 standard. The infrastructure mode wireless LAN communication is a mode in which data communication is performed via access points, whereas, the ad hoc mode is a mode in which data communication is directly performed between devices without using access points.

Japanese Patent Application Laid-open No. 2005-64552 discloses, as a printer that uses the above described wireless LAN communication, a printing apparatus that includes two wireless communication units. The first wireless communication unit directly performs wireless communication with terminal devices in the ad hoc mode. The second wireless communication unit performs, in the infrastructure mode, wireless communication with wireless communication devices other than the terminal devices. Because this printing apparatus is configured such that wireless communication is directly performed with the terminal devices in the ad hoc mode and that the terminal devices are not connected to a wireless communication network, a user of the terminal device cannot access, for example, other terminal devices or servers via the wireless communication network. This makes it possible to prevent the leakage of confidential information contained in the other terminal devices or the servers that are connected to the network, thus ensuring the security.

However, with the printing apparatus disclosed in Japanese Patent Application Laid-open No. 2005-64552, the security of communication data is not ensured when a connection is established in the ad hoc mode. Accordingly, a third party can illegally intercept communication data and also easily obtain communication data that is stored in the connected printing apparatus. Furthermore, there is a problem in that the printing apparatus has a lack of versatility because only wireless LAN communication is used in the wireless communication system when the printing apparatus communicates with the terminal device; in that the printing apparatus cannot perform data communication with communication devices using other wireless communication systems; and in that various settings cannot be set for the wireless communication.

### SUMMARY OF THE INVENTION

It is an object of the present invention to at least partially solve the problems in the conventional technology.

According to an aspect of the present invention, there is provided an image processing apparatus that can perform wireless communication, the image processing apparatus including a sub communication unit that receives an association process request using wireless communication and performs an association process; and a main communication unit that performs wireless communication in accordance with association information that is used in the association process and setup information that is setting information on wireless communication that can be set for each system of the association process request.

According to another aspect of the present invention, there is provided a method performed by an image processing apparatus that can perform wireless communication, the method including performing an association process by receiving an association process request using wireless communication; and performing wireless communication in accordance with association information that is used in the association process and setup information that is setting information on wireless communication that can be set for each system of the association process request.

According to another aspect of the present invention, there is a computer program product comprising a computer usable medium having computer readable program codes embodied in the medium that when executed causes a computer to execute, performing an association process by receiving an association process request using wireless communication; and performing wireless communication in accordance with association information that is used in the association process and setup information that is setting information on wireless communication that can be set for each system of the association process request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a communication system 100 according to an embodiment;

FIG. 2 is a functional block diagram illustrating an image processing apparatus 130 according to the embodiment;

FIG. 3 is a flowchart illustrating the flow of a process in which the image processing apparatus 130 according to the embodiment establishes wireless communication with a portable terminal device 140;

FIG. 4 is a schematic diagram illustrating a UI 410 that performs a management setting of setup information according to the embodiment;

FIG. 5 is a schematic diagram illustrating a UI 510 that performs a management setting of setup information according to another embodiment; and

FIG. 6 is a schematic diagram illustrating a UI 610 that displays a communication system of a main communication unit specified by setup information management UIs 410 and 510.

### DETAILED DESCRIPTION OF THE PREFERRED EMBODIMENTS

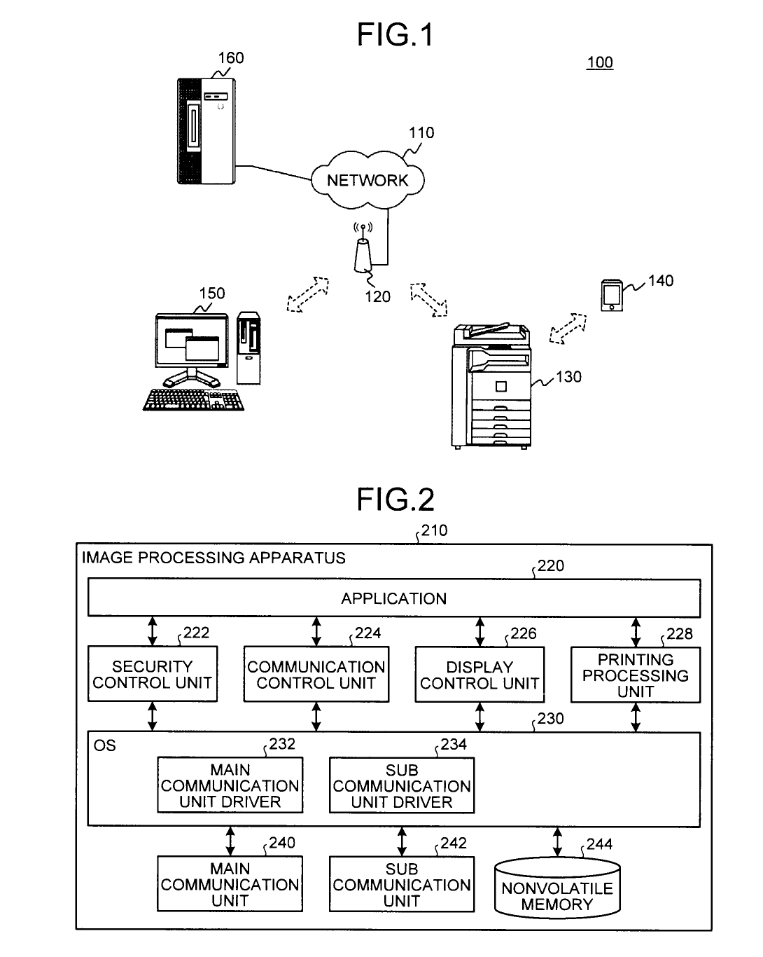

In the following the present invention will be described using an embodiment; however, the present invention is not limited to the embodiment described below. FIG. 1 is a schematic diagram illustrating a communication system 100 according to the embodiment. The communication system 100 is configured such that it includes a network 110, a base station device 120 connected to the network 110, an image processing apparatus 130, a portable terminal device 140, a client personal computer (PC) 150, and a server device 160. The network 110 is configured as a network that uses, for example, an Ethernet (registered trademark) and a TCP/IP protocol. Furthermore, the network 110 can be implemented as a local area network (LAN).

The base station device 120 is a radio wave relay device that allows wireless LAN communication and is used as an access point among the image processing apparatus 130, the portable terminal device 140, and the client PC 150. The base station device 120 is connected to the network 110. The image processing apparatus 130, the portable terminal device 140, and the client PC 150 can access, via the base station device 120, the server device 160 connected to the network 110.

The image processing apparatus 130 is configured as an image processing apparatus that has a wireless communication function. The image processing apparatus 130 can perform a printing process by receiving, using wireless communication via the base station device 120, print data, such as image data or text data. Furthermore, in addition to performing a printing process by receiving print data via the base station device 120 in an infrastructure mode, the image processing apparatus 130 can also performs a printing process by directly receiving, from the portable terminal device 140 or the like, print data in an ad hoc mode that is a peer-to-peer connection.

The image processing apparatus 130 can include a scanning apparatus that is configured to include a charge coupled device (CCD) sensor or the like. The image processing apparatus 130 can send scan data that is scanned by a scanning apparatus to the portable terminal device 140, the client PC 150, or the server device 160 using wireless communication.

The image processing apparatus 130 includes, for example, a processor, a ROM, a RAM, and a hard disk drive (HDD). The image processing apparatus 130 executes, under an operating system (OS), such as UNIX (registered trademark) or LINUX (registered trademark), a program of the embodiment written in a programming language, such as an assembler, C, C++, JAVA (registered trademark), or Java (registered trademark) Script, thereby implementing a function, which will be described later. The image processing apparatus 130 can be configured as a multi function printer (MFP) that is a multifunctional image processing apparatus capable of, for example, printing, scanning, and copying.

The portable terminal device 140 is a terminal device that has a wireless communication function. The portable terminal device 140 can allow the image processing apparatus 130 to perform a printing process by sending print data using the ad hoc communication. Furthermore, the portable terminal device 140 can receive, using the ad hoc communication, various kinds of data, such as image data, that is scanned by the image processing apparatus 130. Furthermore, the portable terminal device 140 can access the server device 160 via the base station device 120. Examples of such a portable terminal device 140 include mobile devices, such as personal digital assistants (PDAs), laptop computers, and mobile phones; however, the portable terminal device 140 is not limited thereto.

The client PC 150 is a terminal device that has a wireless communication function. The client PC 150 can allow the image processing apparatus 130 to perform a printing process by sending print data via the base station device 120 using wireless communication. Furthermore, the client PC 150 can access the server device 160 via the base station device 120 using wireless communication.

The server device 160 can receive/supply various kinds of data from/to the image processing apparatus 130, the portable terminal device 140, and the client PC 150 using the wireless communication via the base station device 120.

FIG. 2 is a functional block diagram illustrating the image processing apparatus 130 according to the embodiment. In the following, a processing function included in the image processing apparatus 130 will be described with reference to FIG. 2.

The image processing apparatus 210 includes an application 220, a security control unit 222, a communication control unit 224, a display control unit 226, and a printing processing unit 228. The application 220 is a program that executes an association process for establishing a connection using wireless communication and establishes wireless communication between the image processing apparatus 210, the base station device 120, and the portable terminal device 140. In the association process, wireless communication is established by both of the communication devices sharing connection information (hereinafter, referred to as “association information”), such as identification information on the wireless LAN network, such as an extended service set identifier (ESSID) or a service set identifier (SSID); sharing authentication information, such as a MAC address or an unique identification number, that uniquely identifies a portable terminal device or a base station device; and sharing encryption information, such as a encryption key that encrypts communication data.

The security control unit 222 is a function unit that stores security information, such as association information, in a nonvolatile memory in the image processing apparatus 210 or obtains the security information from the nonvolatile memory. The association information stored as the security information is stored for a period specified by a user using an user interface that manages and sets setup information that is setting information on wireless communication displayed on an operation panel in the image processing apparatus 130 (hereinafter, referred to as a “setup information setting UI”). Furthermore, the security control unit 222 can delete the association information if wireless communication is disconnected or if wireless communication is in an idle state. The user can specify, using the setup information setting UT, whether the association information is deleted.

In another embodiment, the security control unit 222 can store, in a nonvolatile memory, the association information on the portable terminal device 140 with which wireless communication is established. Then, using authentication information on the association information on the portable terminal device 140 that previously performed wireless communication, the application 220 performs an authentication process to establish wireless communication. Accordingly, the association process can be simplified.

The communication control unit 224 is a function unit that controls wireless communication of the image processing apparatus 130. The communication control unit 224 controls a main communication unit 240 and a sub communication unit 242 using a device driver 232 of the main communication unit 240 and a device driver 234 of the sub communication unit 242 that will be described later. The communication control unit 224 sends to/receives from, the base station device 120 or the portable terminal device 140 via the sub communication unit 242, association information to establish wireless communication. Then, the communication control unit 224 performs, with respect to the main communication unit 240, wireless LAN communication, ultra wide band (UWB) communication using a wireless USB (WUSB), and wireless communication using Bluetooth.

Furthermore, the communication control unit 224 monitors the communication state of the main communication unit 240 and the sub communication unit 242 and stores the communication state in a storage unit such as a RAM (not shown) in the image processing apparatus 130. In the embodiment, using an event notification (e.g., a normal notification or an error notification) that indicates the communication state issued by the main communication unit 240 and the sub communication unit 242, the communication control unit 224 determines the communication state of the main communication unit 240 and the sub communication unit 242. Furthermore, using an event notification that indicates the commencement or completion of communication issued by the main communication unit 240 and the sub communication unit 242, the communication control unit 224 determines the commencement or completion of wireless communication.

Furthermore, if the setup information setting UI specifies the time available for wireless communication, the communication control unit 224 can end wireless communication after the specified time has elapsed. At this time, if the setup information setting UI specifies that the association information is to be deleted, the security control unit 222 deletes the association information stored in the nonvolatile memory in the image processing apparatus 130.

Furthermore, the communication control unit 224 can communicate with the portable terminal device 140 by encrypting communication data. In addition to an encryption key specified by an administrator of the image processing apparatus 130, an encryption key held by the portable terminal device 140 can be used for encrypting the communication data. When the encryption key held by the portable terminal device 140 is used, only a high security encryption key subjected to an association process, which will be described later, is permitted.

The display control unit 226 is a function unit that controls a display unit, such as an operation panel arranged in the image processing apparatus 130. The display control unit 226 displays the setup information setting UI on the display unit in the image processing apparatus 130 and receives setup information specified by a user. Then, the display control unit 226 stores the setup information in the nonvolatile memory in the image processing apparatus 130. Furthermore, the display control unit 226 obtains the setup information from the nonvolatile memory and displays the setup information on an UI that displays the communication system of the main communication unit. Details of these UIs will be described later together with the information that is displayed.

The printing processing unit 228 is a function unit that receives print data and then prints the print data. After wireless communication is established with a peripheral device, such as the base station device 120 or the portable terminal device 140, the image processing apparatus 210 receives print data via the base station device 120 or receives print data from, for example, the portable terminal device 140 and allows the printing processing unit 228 to print the print data.

Furthermore, the image processing apparatus 130 includes an operating system (hereinafter, referred to as an “OS”) 230, the main communication unit 240, the sub communication unit 242, and a nonvolatile memory 244.

The OS 230 includes the main communication unit driver 232 and the sub communication unit driver 234. The main communication unit driver 232 is a device driver that controls the main communication unit 240 by controlling data communication performed by the main communication unit 240. The sub communication unit driver 234 is a device driver that controls the sub communication unit 242 by controlling data communication performed by the sub communication unit 242.

The main communication unit 240 is a device that performs wireless communication with a peripheral device. In accordance with setup information, which will be described later and which is setting information of wireless communication, wireless communication is available, such as wireless LAN communication, performed in the infrastructure mode or in the ad hoc mode; UWB communication using an WUSB; and wireless communication using Bluetooth. In the embodiment, in the wireless LAN communication in the infrastructure mode, the main communication unit 240 receives data, such as print data, via the base station device 120. Furthermore, in the wireless LAN communication in the ad hoc mode, the main communication unit 240 receives data, such as print data, from the portable terminal device 140 or sends scan data to the portable terminal device 140. Furthermore, in the UWB communication using the WUSB, the main communication unit 240 receives data, such as print data, from the WUSB or the like or sends scan data to, for example, the WUSB. Furthermore, in wireless communication using Bluetooth, the main communication unit 240 receives data, such as print data, from the portable terminal device 140 or sends scan data to the portable terminal device 140.

The image processing apparatus according to the embodiment includes a single main communication unit; however, in another embodiment, multiple main communication units can be included. In such a case, wireless communication can be performed by specifying, for each main communication unit, for example, wireless LAN communication, WUSB communication, and Bluetooth.

The sub communication unit 242 is a device that performs an association process for establishing wireless communication with a peripheral device. In the embodiment, in a near field communication (NFC) system or a push button configuration (PBC) system, the sub communication unit 242 sends to/receives from the peripheral device association information. In another embodiment, the sub communication unit 242 can send to/receive from the peripheral device the association information in a personal identification number (PIN) system.

The nonvolatile memory 244 stores therein association information that is used in the association process. The association information is stored, for each portable terminal device 140 that performs wireless communication, in the nonvolatile memory 244 for a period of time specified by the user. Furthermore, the nonvolatile memory 244 stores therein setup information that is set by the setup information setting UI or information constituting the setup information setting UI. A system administrator or the like can register the information constituting the setup information setting UI in the image processing apparatus 130.

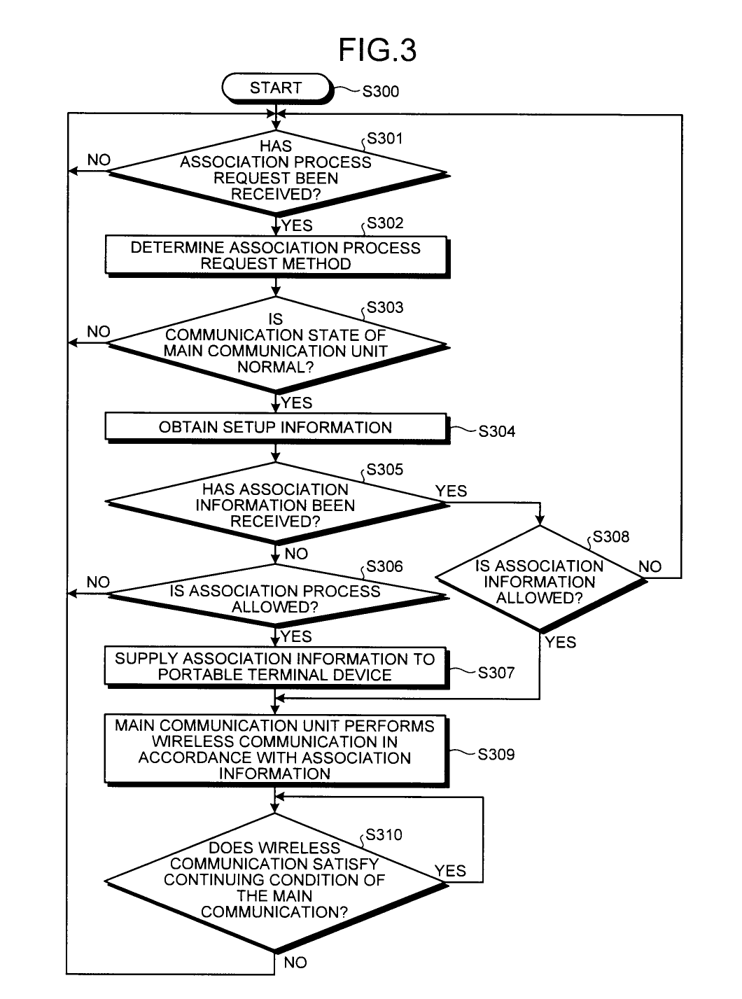

FIG. 3 is a flowchart illustrating the flow of a process in which the image processing apparatus 130 according to the embodiment establishes wireless communication with the portable terminal device 140. In the following, a process for establishing wireless communication will be described with reference to FIG. 3.

The process illustrated in FIG. 3 starts at Step S300. At Step S301, the sub communication unit 242 in the image processing apparatus 130 determines whether an association process request (hereinafter, referred to as an “association process request”) is received. If the sub communication unit 242 determines that an association process request is not received (No at Step S301), the sub communication unit 242 repeats the process of Step 5301. In contrast, if the sub communication unit 242 determines that an association process request is received (Yes at Step S301), the process proceeds to Step S302.

At Step S302, the sub communication unit 242 notifies the application 220 that the association process request is received, and the application 220 determines the type of method of requesting the association process from the association process request (hereinafter, referred to as an “association process request method”). In the embodiment, information that identifies the association process request method is contained in the association process request. The application 220 can determine the association process request method using the information. Furthermore, in the embodiment, the association process request method can be a request method using the NFC system, the PBC system, or the PIN system.

At Step S303, the application 220 obtains the communication state of the main communication unit that is stored in the RAM in the image processing apparatus 130 and determines whether the communication state of the main communication unit is normal. If the communication state of the main communication unit is normal (Yes at Step S303), the process proceeds to Step S304. In contrast, if the communication state of the main communication unit indicates an error (No at Step S303), the process returns to Step S301 and repeats the process. In another embodiment, if the communication state of the main communication unit indicates an error, that state can be displayed on the display unit in the image processing apparatus 130 and be notified to the portable terminal device 140 that is attempting wireless communication.

At Step 5304, the application 220 obtains the setup information stored in the nonvolatile memory 244 and then obtains, for example, the communication system, the communication mode, the encryption condition of communication data, and the continuing condition of the main communication of the main communication unit that is set in the association process request method specified at Step 302. At Step S305, the application 220 determines whether the association information is received from the portable terminal device 140 via the sub communication unit 242. If the application 220 determines that the association information is not received (No at Step S305), the process proceeds to Step S306.

At Step S306, the application 220 determines, using setup information, whether the association process using the association process request method can be performed. The determination can be performed by checking whether an association process request method, for example, association using the NFC, the PBC, or the PIN, is allowed. Furthermore, the determination can be performed by checking whether a portable terminal device that sends an association process request can use an encryption key that satisfies the encryption condition. Furthermore, the determination can also be performed, by a portable terminal device that sends an association process request, using authentication information, such as identification information or a MAC address that are not allowed to be connected using wireless communication.

If the application 220 determines that the association process using the association process request method cannot be performed (No at Step S306), the process returns to Step S301 and repeats the process. In contrast, if the application 220 determines that the association process using the association process request method can be performed (Yes at Step S306), the process proceeds to Step S307. At Step 5307, the application 220 supplies the association information to the portable terminal device 140 via the sub communication unit 242.

In contrast, if the application 220 determines that the association information is received (Yes at Step S305), the process proceeds to Step S308. At Step S308, the application 220 determines whether the association information received from the portable terminal device 140 can be allowed. This determination can be performed in a similar manner as that performed at Step S306.

If the application 220 determines that the association information cannot be allowed (No at Step S308), the process returns to Step S301 and repeats the process. In contrast, if the application 220 determines that the association information can be allowed (Yes at Step S308), the process proceeds to Step 5309.

At Step S309, the main communication unit 240 performs wireless communication with the portable terminal device 140 in accordance with the setup information and the association information. At Step S310, the application 220 determines whether wireless communication performed by the main communication unit 240 satisfies the continuing condition of the main communication obtained at Step S304. If the application 220 determines that the continuing condition of the main communication is satisfied (Yes at Step S310), the process of Step 5310 is repeated. If the application 220 determines that the continuing condition of the main communication is not satisfied (No at Step S310), the process returns to Step S301 and repeats the process.

In the embodiment, after the main communication unit 240 establishes wireless communication at Step 5309, the image processing apparatus 130 receives print data via the main communication unit 240 from the portable terminal device 140 in which communication is established and then allows the printing processing unit 228 to print the print data.

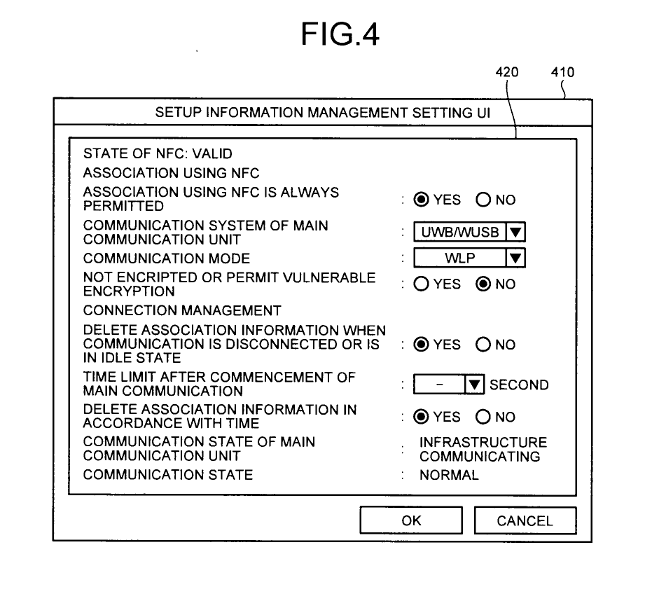

FIG. 4 is a schematic diagram illustrating the setup information setting UI 410 according to the embodiment. The setup information setting UI 410 is a UI that sets setup information on the association using the NFC system. If the sub communication unit 242 in the image processing apparatus 130 receives an association process request using the NFC system, the application 220 allows the main communication unit to perform wireless communication in accordance with the setup information specified by the setup information setting UI 410.

The setup information setting UI 410 includes a field 420 that sets setup information on the association process using the NFC system. The field 420 includes a radio button that specifies whether the association process using the NFC system is always permitted. A user can specify, using the radio button, whether the image processing apparatus 130 performs the association process using the NFC system. In the embodiment, if a user specifies that the association process using the NFC system is always permitted, “valid” is displayed as the “NFC state” in the field 420. In contrast, if a user specifies that the association process using the NFC system is always not permitted, “invalid” is displayed as the “NFC state” in the field 420.

Furthermore, the field 420 includes a pull-down menu with which the communication system of the main communication unit is specified. In FIG. 4, UWB/WUSB is selected as the communication system of the main communication unit. In the embodiment, wireless LAN communication, Bluetooth, or the like can be specified as the communication system of the main communication unit. In the embodiment, wireless LAN 1 or 2 can be specified as the wireless LAN communication. The wireless LAN 1 indicates wireless communication in the ad hoc mode, where a logical network that is established by the wireless communication using the ESSID or the SSID can be specified. The wireless LAN 2 indicates wireless communication in the infrastructure mode, where a logical network that is established by the wireless communication using the ESSID or the SSID, can be specified in a similar manner to the wireless LAN 1.

Furthermore, the field 420 also includes a pull-down menu with which the communication mode of the main communication unit is specified. In FIG. 4, WiMedia Link-layer protocol (WLP) that is a protocol used in the UWB is selected as the communication mode of the main communication unit. In the embodiment, in addition to the WLP, the ad hoc mode or the like can be specified as the communication mode in the main communication unit.

Furthermore, the field 420 also includes the radio button for specifying permission of the encryption condition for communication data, i.e., specifying whether to permit the encryption of data that is transmitted using wireless communication. The radio button is also used to specify whether to permit the use of a vulnerable encryption. A user can request, using the radio button, encryption of wireless communication data. Accordingly, with the image processing apparatus according to the embodiment, the security of wireless communication data can be enhanced.

The field 420 further includes a radio button that is used to specify whether to delete association information if wireless communication is disconnected or if wireless communication is not performed, i.e., in an idle state. A user can specify, using this radio button, whether to delete the association information.

Furthermore, the field 420 includes a pull-down menu that specifies the wireless communication time. The communication control unit 224 in the image processing apparatus 130 ends wireless communication if wireless communication time reaches the time specified by the pull-down menu. In the embodiment, the communication time used can be in seconds; however, in another embodiment, the communication time used can be in seconds or hours. Furthermore, if the time specified by the pull-down menu has elapsed, the field 420 further includes a radio button that specifies whether to delete the association information. When the radio button specifies that association information is deleted, if wireless communication ends because the wireless communication time reaches the predetermined time, the security control unit 222 in the image processing apparatus 130 deletes the association information on the wireless communication stored in the nonvolatile memory 244.

The field 420 further includes a field that indicates a state of the main communication unit or a communication state thereof. The display control unit 226 receives, from the communication control unit 224, a state of the main communication unit or a communication state thereof and displays it on the setup information setting UI 410.

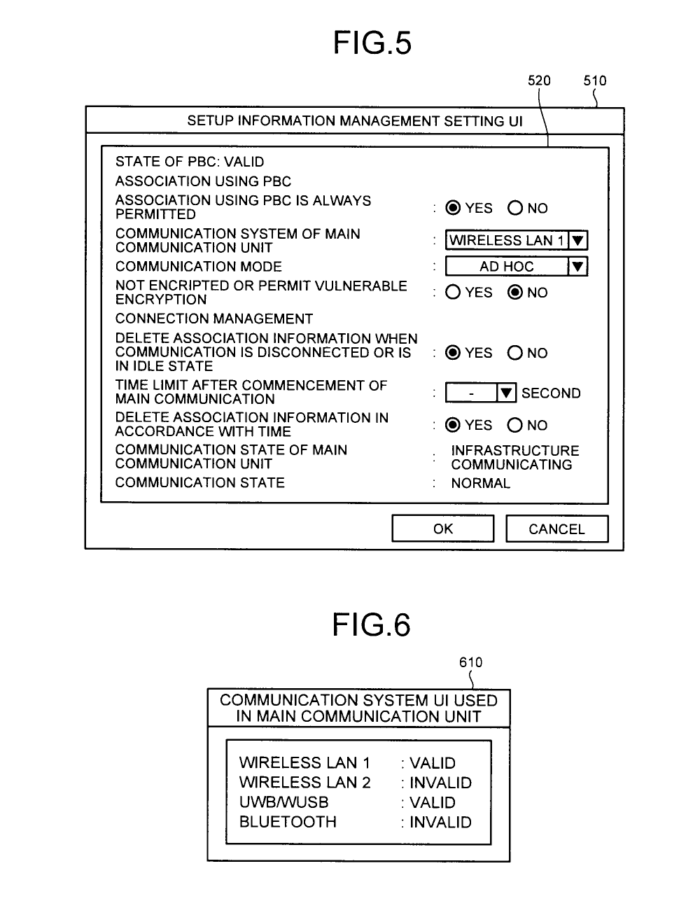

FIG. 5 is a schematic diagram illustrating a UI 510 that performs management setting of setup information according to another embodiment. The setup information setting UI 510 is a UI that sets setup information on the association using the PBC system. If the sub communication unit 242 in the image processing apparatus 130 receives an association process request using the PBC system, the application 220 allows the main communication unit to perform wireless communication in accordance with the setup information specified by the setup information setting UI 510. The function of the setup information setting UI 510 is the same as that of the setup information setting UI 410 that sets association using the NFC system. Accordingly, a description thereof in detail will be omitted.

FIGS. 4 and 5 are schematic diagrams illustrating setup information setting UIs that set association using the NFC system or the PBC system; however, in another embodiment, setup information can be specified using a setup information setting UI that sets association using the PIN system, which is similar to the setup information setting UIs 410 and 510.

FIG. 6 is a schematic diagram illustrating a UI 610 that displays a communication system of a main communication unit specified by the setup information management UIs 410 and 510 illustrated in FIGS. 4 and 5. The display control unit 226 obtains, from the nonvolatile memory 244 in the image processing apparatus 130, information specified by the setup information setting UI and displays the information on the UI 610. A user can determine, by referring to the UI 610, which communication system is valid in the main communication unit.

In the embodiment, communication is established with, for example, a terminal device that has a wireless communication function; however, in another embodiment, the image processing apparatus can establish communication with other terminal devices using a wire. In such a case, the image processing apparatus can establish communication by receiving connection information, such as authentication information including a MAC address or an individual identification number that uniquely identify a terminal device, encryption information including an encryption key that encrypts communication data, or the like. Accordingly, it is also possible to improve the security of communication data using a wire.

According to an aspect of the present invention, in accordance with an association process request system, it is possible to switch wireless communication systems performed by a main communication unit.

According to another aspect of the present invention, a user can arbitrarily select a communication system or a communication mode of wireless communication used in the main communication unit, thus enhancing general versatility of wireless communication. Furthermore, it is possible to eliminate wireless communication with a communication device that uses a vulnerable encryption key, thus enhancing the security of communication data received by an image processing apparatus. Furthermore, because it is possible to end wireless communication between the main communication unit and a communication device after a predetermined time has elapsed, unnecessary latency time can be reduced in a case in which a communication device performs wireless communication with the image processing apparatus and then another communication device establishes wireless communication with the image processing apparatus.

Furthermore, the present invention provides a method that is performed by the image processing apparatus that can perform data communication using wireless communication established by performing an association process, and the present invention provides a program and a recording medium therefor.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that can perform wireless communication, the image processing apparatus comprising:
a sub communication unit that receives an association process request using wireless communication and performs an association process; and
a main communication unit that performs wireless communication in accordance with association information that is used in the association process and setup information that is setting information on wireless communication that can be set for each system of the association process request.

2. The image processing apparatus according to claim 1, wherein the sub communication unit receives an association process request using an NFC system, a PBC system, or a PIN system.

3. The image processing apparatus according to claim 1, wherein the setup information includes a communication system, a communication mode, an encryption condition for communication data, or a communication continuing condition, which is used in the main communication unit.

4. The image processing apparatus according to claim 3, wherein
the communication system includes wireless communication using wireless LAN communication, UWB communication, and Bluetooth, and
if the communication system is the wireless LAN communication, the communication mode is an ad hoc mode or an infrastructure mode.

5. A method performed by an image processing apparatus that can perform wireless communication, the method comprising:
performing an association process by receiving an association process request using wireless communication; and
performing wireless communication in accordance with association information that is used in the association process and setup information that is setting information on wireless communication that can be set for each system of the association process request.

6. The method according to claim 5, wherein the performing the association process includes receiving an association process request using an NFC system, a PBC system, or a PIN system.

7. The method according to claim 5, wherein the setup information includes a communication system of wireless communication, a communication mode of wireless communication, an encryption condition for communication data of wireless communication, or a communication continuing condition of wireless communication, which is performed at the performing of the wireless communication.

8. The method according to claim 7, wherein
the communication system includes wireless communication using wireless LAN communication, UWB communication, and Bluetooth, and
if the communication system is the wireless LAN communication, the communication mode is an ad hoc mode or an infrastructure mode.

9. A computer program product comprising a computer usable medium having computer readable program codes embodied in the medium that when executed causes a computer to execute:
performing an association process by receiving an association process request using wireless communication; and
performing wireless communication in accordance with association information that is used in the association process and setup information that is setting information on wireless communication that can be set for each system of the association process request.

10. A computer readable recording medium that stores therein the program according to claim 9.
